(19) United States
(12) Patent Application Publication
(10) Pub. No.: US 2025/0359610 A1
(43) Pub. Date: Nov. 27, 2025

(54) FLUID-FILLED DAMPER SYSTEM WITH RESTRICTED FLOW

(71) Applicant: NIKE, Inc., Beaverton, OR (US)

(72) Inventors: Joseph B. Gault, West Linn, OR (US); Andrew C. Lau, Happy Valley, OR (US); Jazzmin P. Martinez, Beaverton, OR (US); Austin J. Orand, Portland, OR (US); Jan Raken, Seattle, WA (US); Daniel Weeks, Portland, OR (US)

(73) Assignee: NIKE, Inc., Beaverton, OR (US)

(21) Appl. No.: 19/219,820

(22) Filed: May 27, 2025

Related U.S. Application Data
(60) Provisional application No. 63/651,940, filed on May 24, 2024.
(60) Provisional application No. 63/651,435, filed on May 24, 2024.

(51) Int. Cl. A41D 13/015; A41D 13/05; A41D 13/06

(52) U.S. Cl. CPC A41D 13/015; A41D 13/055; A41D 13/06

(57) ABSTRACT

A fluid-filled damper system for apparel and protective padding manages impact forces through controlled fluid movement between chambers. The system includes a flexible bladder defining first and second fluid chambers connected by a flow restrictor that limits fluid transfer rate between chambers. When force is applied to the first chamber, fluid displaces into the second chamber at a rate regulated by the flow restrictor, creating progressive damping that varies with compression rate.

### CROSS-REFERENCE TO RELATED APPLICATION

This application claims the benefit of priority to U.S. Provisional Application No. 63/651,940, filed May 24, 2024, and U.S. Provisional Application No. 63/651,435, filed May 24, 2024, both of which are incorporated by reference in their entirety.

### TECHNICAL FIELD

The present disclosure relates generally to impact and vibration management systems for apparel and footwear, and more particularly to fluid-filled dampers that utilize restricted flow between chambers to create controlled, progressive damping responses in wearable applications.

### BACKGROUND

Impact and vibration management presents significant challenges in apparel and protective padding applications, particularly in athletic and performance contexts where variable force inputs must be managed effectively while maintaining wearer comfort and mobility. Wearable protection systems require adaptive response characteristics that can accommodate the diverse range of impact velocities and magnitudes encountered during athletic activities.

Conventional damping approaches in protective apparel often exhibit limitations when applied to wearable applications requiring adaptive response characteristics. Fixed-response damping materials typically provide linear response to compression that cannot adapt to different force inputs experienced during various athletic activities. Such materials commonly suffer from performance degradation over time due to compression set, environmental exposure, or repeated cycling, presenting durability concerns for performance apparel applications.

Simple fluid-based systems present their own limitations in wearable applications. Single-chamber fluid systems tend to compress uniformly under load, providing minimal directional control of energy dissipation during complex movements typical of athletic activities. Additionally, such systems often lack the progressive response characteristics necessary for effective protection across varying impact conditions.

There exists a need for an improved damping system specifically designed for apparel and protective padding that provides adaptive performance characteristics necessary for effective protection during athletic activities. Such a system should offer progressive response to varying impact conditions while maintaining the lightweight, flexible characteristics essential for wearable applications. Furthermore, the system should achieve these characteristics through a self-contained design that operates reliably without external control systems or power sources.

### SUMMARY

The present disclosure provides a fluid-filled damper system with restricted flow that effectively manages impact forces and vibrations in apparel and protective padding through controlled fluid movement between chambers. The system utilizes strategically positioned fluid chambers with an engineered flow restrictor to create a progressive damping response that varies with the rate of compression, enhancing both protection and comfort in wearable applications.

The fluid-filled damper system comprises a flexible bladder defining a first fluid chamber and a second fluid chamber, with a flow restrictor providing fluidic communication between the chambers. The flow restrictor is configured to limit the rate of fluid transfer between the first fluid chamber and the second fluid chamber. When force is applied to the first fluid chamber during athletic activity, fluid is displaced into the second fluid chamber through the flow restrictor, which limits the rate of fluid transfer and creates a progressive damping effect proportional to both the magnitude and rate of the applied force.

The system's design enables it to respond differently to various force inputs experienced during athletic activities, providing progressive resistance that increases with both the magnitude and rate of compression. During high-velocity impacts, the flow restrictor significantly limits fluid movement between chambers, creating greater resistance and enhanced protection. During gradual compression or normal movement, the system allows more fluid transfer and provides a softer response appropriate for comfort and mobility. This adaptive behavior occurs passively without requiring external control systems, electronic components, or external power sources.

In some embodiments, the flow restrictor comprises a necked transition zone extending between the first fluid chamber and the second fluid chamber, with a cross-sectional area smaller than the cross-sectional areas of both chambers to create the desired flow limitation characteristics. The flow restrictor may be configured to provide directionally-dependent flow resistance such that the rate of fluid transfer differs between directions under equivalent pressure differentials. The first fluid chamber and second fluid chamber may have different internal volumes to create a progressive damping response during compression and recovery cycles, with typical configurations featuring a larger first chamber to provide initial compliance followed by progressive resistance.

The system incorporates durable, impermeable construction that maintains performance over numerous compression cycles and across a range of environmental conditions encountered in apparel and protective padding applications. The fluid-filled damper system can be integrated into articles of apparel, including athletic apparel selected from protective sportswear, compression wear, and technical performance clothing. The system may also be implemented in protective pads for athletic equipment, positioned between a protective outer shell and a comfort layer. The flexible bladder is configured to conform to body contours when worn, providing protection without restricting natural movement. The fluid contained within the chambers may comprise gaseous media such as air, nitrogen, helium, or combinations thereof. The flexible bladder can be constructed from materials such as thermoplastic polyurethane (TPU), polyvinyl chloride (PVC), or other flexible, resilient polymers suitable for containing the working fluid. The system can be scaled and configured for integration into diverse products ranging from athletic apparel protective elements to specialized protective padding for contact sports and high-impact activities.

### BRIEF DESCRIPTION OF THE DRAWINGS

The accompanying drawings, which are incorporated in and constitute a part of this specification, illustrate various embodiments of the fluid-filled damper system and, together with the detailed description, serve to explain the principles of the design.

FIG. 1 is a perspective view of a fluid-filled damper system integrated into a protective pad for athletic apparel, illustrating the spatial relationship between the flexible bladder and surrounding protective elements.

FIG. 2A is a cross-sectional view of the protective pad of FIG. 1, taken along line A-A, showing the layered construction with the fluid-filled damper system positioned between the protective outer shell and comfort layer.

FIG. 2B is a cross-sectional view of the protective pad of FIG. 1, taken along line B-B, illustrating the flow restrictor configuration and chamber arrangement within the flexible bladder.

FIG. 3 is a cross-sectional view, such as taken along the line C-C of the fluid-filled damper system of FIG. 1, showing fluid flow from the first fluid chamber to the second fluid chamber during compression from impact forces applied during athletic activity.

FIG. 4 is a cross-sectional view, such as taken along the line C-C of the fluid-filled damper system of FIG. 1, of the fluid-filled damper system showing fluid flow returning from the second fluid chamber to the first fluid chamber during recovery after impact, illustrating the controlled return flow through the flow restrictor.

FIG. 5 is a cross-sectional view of an alternative embodiment of the fluid-filled damper system with an elongated channel passage serving as the flow restrictor between chambers.

FIG. 6 is a graph illustrating force-displacement characteristics of the fluid-filled damper system compared to conventional damping systems, demonstrating the progressive response characteristics at different compression rates.

FIG. 7 is a perspective view of the fluid-filled damper system implemented in athletic apparel, showing integration within a compression sleeve for impact protection during athletic activities.

FIG. 8 is a perspective view of the fluid-filled damper system implemented in protective sports equipment, illustrating application in football shoulder pads and contact sports protective gear.

### DETAILED DESCRIPTION

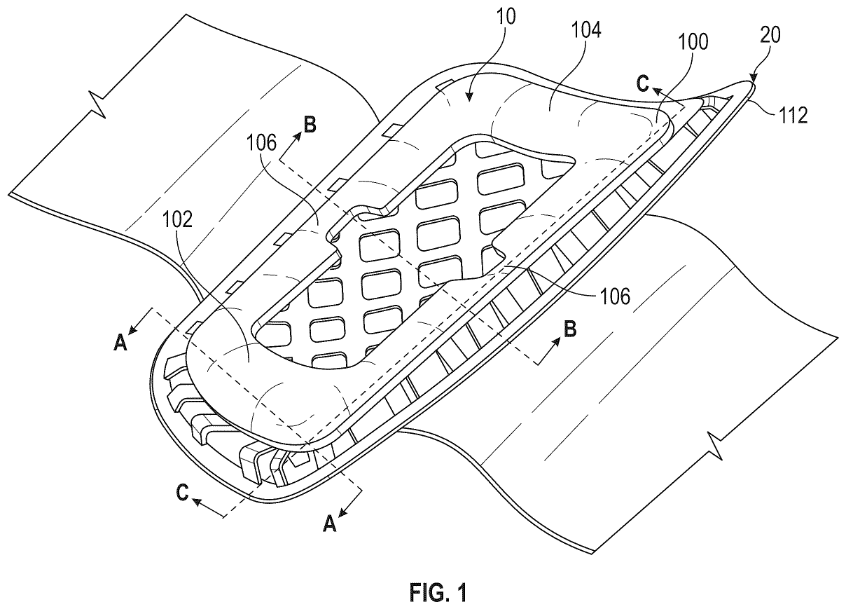

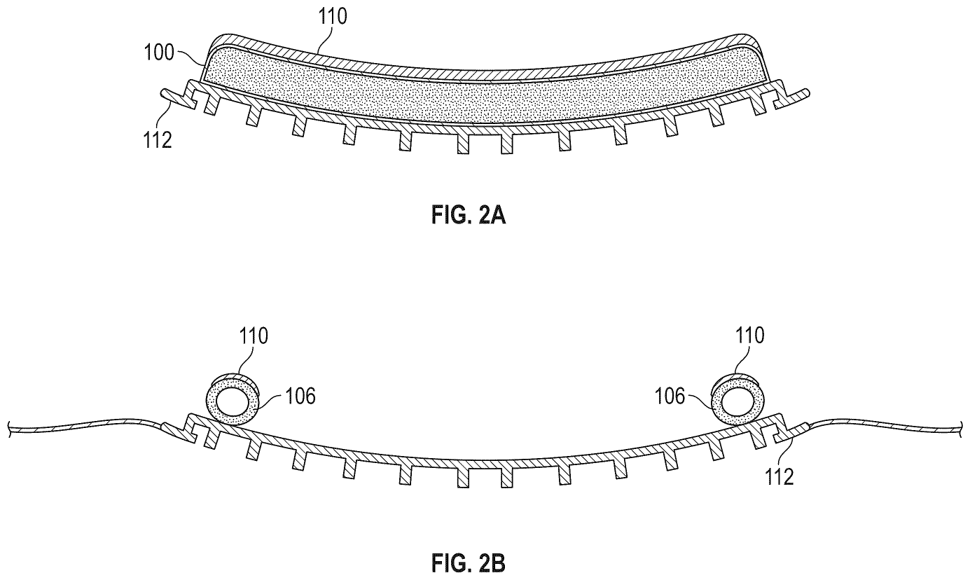

Referring to the figures, where like numerals are intended to refer to common elements across the various figures, FIGS. 1 and 2 generally illustrate the fluid-filled damper system 10 incorporated into a protective pad 20 for athletic apparel.

The fluid-filled damper system 10 comprises a flexible bladder 100 defining a first fluid chamber 102 and a second fluid chamber 104. A flow restrictor 106 provides fluidic communication between the first fluid chamber 102 and the second fluid chamber 104, with the flow restrictor 106 configured to limit the rate of fluid transfer between the chambers. The flexible bladder 100 contains a fluid 114 within both the first fluid chamber 102 and the second fluid chamber 104. This multi-chamber configuration with restricted flow enables the system 10 to provide adaptive, progressive damping in response to forces experienced during athletic activities.

As illustrated in FIG. 2 (referring to FIGS. 2A and 2B), the flexible bladder 100 may be positioned between a protective outer shell 112 and a comfort layer 110 that contacts the wearer's body, providing both protection and comfort during athletic activities.

The flow restrictor 106 comprises a necked transition zone extending between the first fluid chamber 102 and the second fluid chamber 104. In typical embodiments, the necked transition zone has a cross-sectional area that is approximately 2% to 50% of the cross-sectional areas of the adjacent chambers, though this ratio may be optimized for specific applications. The flow restrictor 106 is configured to limit the rate of fluid transfer between the first fluid chamber 102 and the second fluid chamber 104, creating the characteristic progressive damping effect of the system.

### Progressive Damping Mechanism and Operation

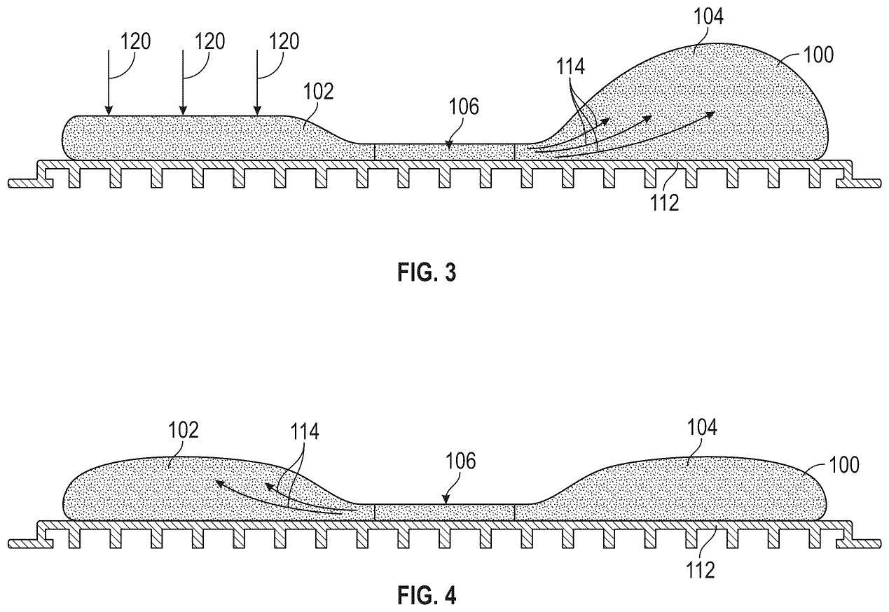

As shown in FIG. 3, when an impact force 120 is applied to the first fluid chamber 102 during athletic activity, typically through the protective outer shell 112, the fluid 114 contained within the first fluid chamber 102 is compressed and partially displaced into the second fluid chamber 104. This fluid displacement does not occur instantaneously due to the flow restrictor 106, which limits the rate at which fluid can transfer between the first fluid chamber 102 and the second fluid chamber 104.

This restriction creates a progressive damping effect that varies with the rate of compression applied to the first fluid chamber 102, effectively dampening the impact force by extending its dissipation over time and reducing peak forces transmitted to the wearer's body during athletic activities.

The damping effect is particularly evident during high-velocity athletic movements, when the flow restrictor 106 significantly limits fluid transfer, causing the first fluid chamber 102 to temporarily increase in pressure and provide greater resistance. Conversely, during gradual compression or low-velocity impacts, the flow restrictor 106 permits smoother or mor laminar fluid transfer, resulting in a softer response appropriate for comfort during normal movement.

As illustrated in FIG. 4, once the impact force diminishes, the fluid 114 gradually returns from the second fluid chamber 104 to the first fluid chamber 102 through the flow restrictor 106, again at a rate regulated by the flow restrictor 106. This controlled return helps prevent oscillation or rebound effects that can occur with conventional spring systems in protective apparel, providing more stable support throughout the activity cycle.

### Flow Restrictor Configurations

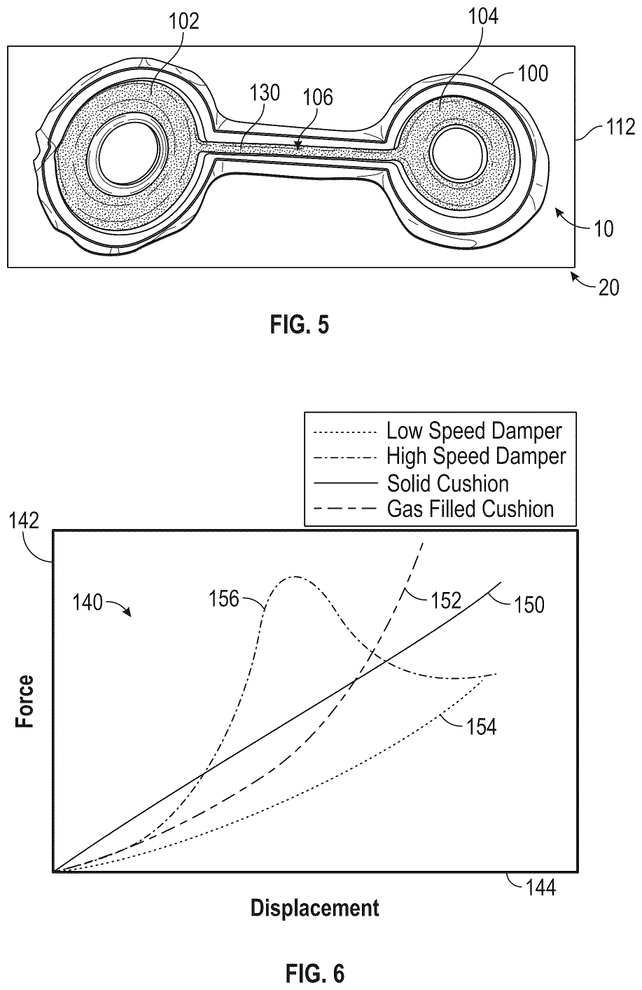

The flow restrictor 106 may take various forms, each optimized for different apparel and protective padding applications. As generally illustrated in FIG. 5, these configurations may include elongated channel passages 130 with varying cross-sectional areas, circular orifices with diameters ranging from approximately 1 mm to 10 mm, labyrinth paths that create longer flow routes for enhanced energy dissipation, or partially obstructed connections that provide directionally-dependent flow resistance. The specific configuration can be selected to achieve the desired damping characteristics for a particular athletic activity or protection requirement.

In some embodiments, the flow restrictor 106 is configured to provide directionally-dependent flow resistance such that the rate of fluid transfer from the first fluid chamber 102 to the second fluid chamber 104 differs from the rate of fluid transfer from the second fluid chamber 104 to the first fluid chamber 102 under equivalent pressure differentials. This asymmetric flow characteristic can be achieved through tapered passages, one-way valve elements, or geometric configurations that create different flow resistance depending on flow direction.

In alternative embodiments, multiple flow restrictors may be incorporated to create complex damping responses. A plurality of flow restrictors providing multiple fluid pathways between the first fluid chamber 102 and the second fluid chamber 104 allows for fine-tuning of the damping characteristics, with individual flow restrictors having different flow resistance characteristics relative to each other.

### Performance Characteristics

The performance characteristics of the fluid-filled damper system are graphically represented in the graph 140 of FIG. 6, which contrasts the reaction force 142 as a function of displacement 144 of the present system with those of conventional damping systems used in apparel and protective padding. Unlike simple foam or rubber dampers that typically provide linear compression resistance 150, or air bladders that follow a standard gas-compression curve 152, the fluid-filled damper system with restricted flow exhibits a distinctive non-linear response that varies as a function of compression rate. More particularly, slower compressions 154 allow the fluid time to displace through the flow restrictor 106, while faster compressions 156 provide an initial resistance that then dissipates over time as the pressures equalize between chambers. These characteristics are particularly valuable for athletic apparel and protective padding applications where adaptive response to varying impact velocities is desired. The system provides progressive resistance that increases proportional to increasing rate of impact forces applied to the fluid-filled damper system, thereby providing greater damping during high-velocity impacts than during low-velocity impacts. This adaptive behavior occurs passively without external control systems, electronic components, or external power sources, making the system ideal for integration into apparel and protective padding products.

### Materials and Construction

The flexible bladder 100 used in the fluid-filled damper system may be constructed from a flexible, resilient material such as thermoplastic polyurethane (TPU), polyvinyl chloride (PVC), or elastomeric polymers, and may include a single layer or multi-layer construction depending on the specific apparel or protective padding application requirements. The flexible bladder 100 is constructed to include a closed internal volume that can maintain a predetermined quantity of fluid without leakage over extended periods of use.

In some embodiments, the flexible bladder 100 comprises at least one impermeable barrier layer integrated into the walls of the flexible bladder 100. The impermeable barrier layer is configured to restrict diffusion of the fluid through the walls of the flexible bladder 100, ensuring consistent performance throughout the lifecycle of the apparel or protective padding product. Common barrier materials include metallized films, ceramic coatings, or specialized polymer layers with low permeability characteristics.

The specific materials selected for the flexible bladder 100 may vary depending on the intended apparel or protective padding application. For applications involving frequent, high-impact athletic activities, more durable and puncture-resistant materials with wall thicknesses of approximately 0.1 mm to 2.0 mm may be appropriate. For applications where weight is a critical factor in performance apparel, thinner materials with reinforcing structures may be preferred.

The flexible bladder 100 may be sealed using various methods such as heat welding, radio-frequency welding, ultrasonic welding, or adhesive bonding to ensure an airtight or fluid-tight seal. In some embodiments designed for performance apparel, the flexible bladder 100 may include reinforced areas around the weld seams or in regions subject to high stress to enhance durability during athletic activities.

### Fluid Media

The fluid contained within the first fluid chamber 102 and the second fluid chamber 104 may be selected based on the specific requirements of the apparel or protective padding application. In many embodiments, the fluid comprises a gaseous medium selected from the group consisting of air, nitrogen, helium, and combinations thereof. Ambient air provides a suitable medium due to its availability, non-toxicity, and appropriate compressibility characteristics for most applications. For applications requiring more consistent performance across temperature ranges encountered during outdoor activities, nitrogen or specialized gas mixtures may be employed due to their reduced moisture content and stable pressure characteristics. In some implementations, particularly those requiring greater damping from a smaller volume within apparel or protective padding, incompressible or partially compressible liquids may be used instead of gases.

### Chamber Configuration and Sizing

The first fluid chamber 102 and the second fluid chamber 104 may have different internal volumes to create a progressive damping response during compression and recovery cycles. In typical embodiments, the first fluid chamber 102 may have an internal volume that is 1.0 to 3 times larger than the second fluid chamber 104, providing initial compliance followed by progressive resistance as fluid is displaced into the smaller secondary volume. The first fluid chamber 102 is positioned to receive primary impact forces during use, while the second fluid chamber 104 is positioned to provide controlled fluid displacement volume. This spatial arrangement, combined with the flow restrictor 106, allows the system to regulate energy dissipation during force application and recovery phases of the damping cycle.

Integration with Protective Padding

As illustrated in FIGS. 1 and 2, the fluid-filled damper system 10 may be integrated into a protective pad 20 for athletic equipment. The protective pad 20 comprises a protective outer shell 112 configured to receive impact forces during athletic activity, a comfort layer 110 configured to contact a wearer's body, and the fluid-filled damper system 10 positioned between the protective outer shell 112 and the comfort layer 110. The protective outer shell 112 may comprise a semi-rigid material configured to distribute impact forces across a surface area of the first fluid chamber 102. Suitable materials for the protective outer shell 112 include high-density polyethylene, polycarbonate, or composite materials that provide impact distribution while maintaining flexibility for wearable applications. The comfort layer 110 is positioned adjacent to the flexible bladder 100 and configured to contact the wearer's body during use. The comfort layer 110 may comprise soft, breathable materials such as foam padding, textile fabrics, or perforated elastomeric materials that provide comfort while allowing the fluid-filled damper system to function effectively. The protective pad is configured to protect a body region selected from the group consisting of a shoulder, an elbow, a hip, a knee, a shin, and a thigh during athletic activity. The flow restrictor 106 is configured such that rapid compression of the first fluid chamber 102 creates greater resistance to fluid transfer than gradual compression of the first fluid chamber 102, providing enhanced protection during sudden impacts compared to sustained pressure.

### Alternative Bladder Configurations

The flexible bladder 100 may have various configurations depending on the overall application requirements. These variations include different chamber sizes, shapes, and arrangements that can be selected based on the specific damping requirements and space constraints of the intended use. For example, a configuration with a substantially larger first fluid chamber 102 and smaller second fluid chamber 104 may be appropriate for applications where initial compliance followed by firm support is desired. Conversely, a design with chambers of similar size may provide more balanced compression and rebound characteristics for general protective applications. In some embodiments, the flow restrictor 106 comprises an elongated channel passage having a cross-sectional area smaller than cross-sectional areas of both the first fluid chamber 102 and the second fluid chamber 104, with the elongated channel passage configured to create controlled energy dissipation during fluid transfer between the chambers.

### Application-Specific Implementations

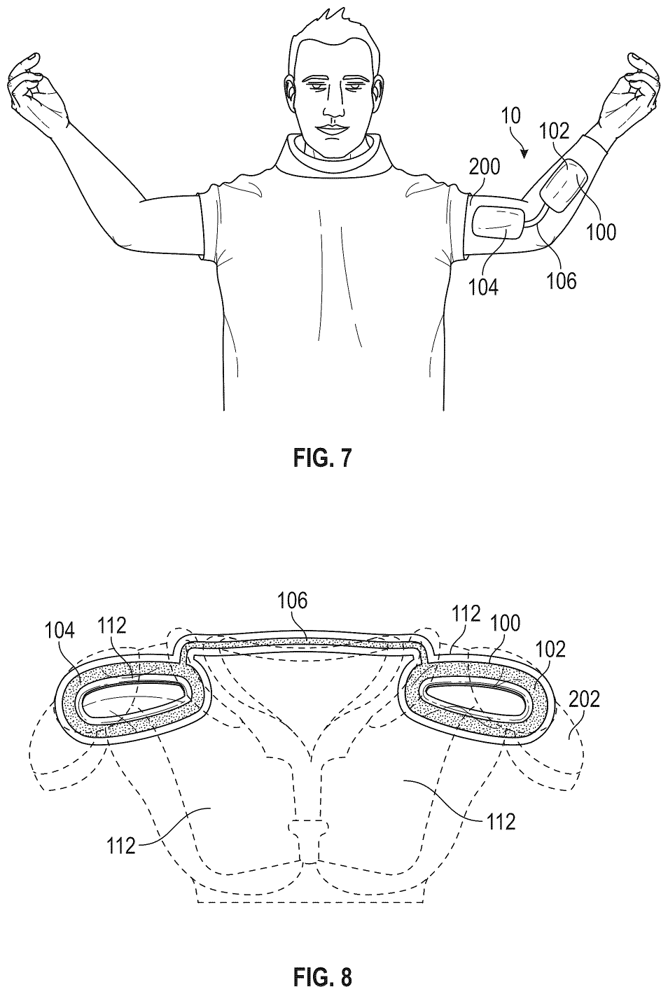

FIG. 7 illustrates the fluid-filled damper system 10 incorporated into an article of apparel 200, where it may be positioned within protective regions such as impact zones, pressure point regions, or joint protection areas. The garment structure comprises athletic apparel selected from protective sportswear, compression wear, and technical performance clothing. In these applications, the flexible bladder 100 is configured to conform to a contour of the portion of the human body when the garment structure is worn, providing both protection and comfort without restricting natural movement. The fluid-filled damper system is positioned within a protective region of the garment structure selected from the group consisting of an impact zone, a pressure point region, and a joint protection area. The flow restrictor 106 is configured to provide progressive resistance that increases proportional to increasing rate of impact forces applied to the fluid-filled damper system, thereby providing greater damping during high-velocity impacts than during low-velocity impacts.

FIG. 8 depicts the fluid-filled damper system 10 implemented in a protective sports garment 202, where it provides impact protection for body regions during athletic activity. The system's ability to provide adaptive damping without external power or control systems makes it particularly valuable in protective apparel where weight, bulk, and reliability are critical considerations.

In some embodiments, a plurality of fluid-filled damper systems may be integrated into different regions of a garment structure, wherein individual fluid-filled damper systems are configured with different damping characteristics appropriate for protection requirements of their respective regions. This allows for customization of protection levels based on the specific impact risks and movement patterns associated with different body areas.

In some embodiments, the fluid-filled damper system may be applied to grip elements in athletic equipment for vibration damping applications. In this implementation, the system reduces the transmission of harmful vibrations to the user's hands, potentially reducing fatigue and the risk of repetitive stress injuries during activities requiring extended grip periods. Multiple interconnected chamber pairs may be optimized for performance apparel applications. This configuration allows for more complex damping responses and can be adapted to garments with multi-directional movement patterns or where different damping characteristics are desired in different regions of the same apparel item.

The performance characteristics of the fluid-filled damper system may be tuned through various design parameters to optimize performance for specific athletic activities or protective functions. The volume ratio between the first fluid chamber 102 and the second fluid chamber 104 influences the progressive nature of the damping response. The size, shape, and number of flow restrictors determine the rate of fluid transfer and thus the time-dependent aspects of the damping effect. The initial pressure within the system affects the overall stiffness and response curve.

In embodiments where enhanced energy dissipation is desired, the flow restrictor 106 may comprise an internal structure configured to create turbulent flow during fluid transfer, further enhancing energy dissipation during compression cycles. Such structures may include internal baffles, surface texturing, or geometric features that promote energy-dissipating flow patterns.

For applications where temperature stability is important, such as outdoor apparel and protective padding, the fluid-filled damper system may incorporate materials with minimal thermal expansion characteristics or may use gas mixtures that exhibit less pressure variation across expected temperature ranges of approximately −20° C. to +60° C. The system maintains consistent damping performance across this temperature range without requiring adjustment or external compensation.

The fluid-filled damper system described herein represents an advancement over conventional damping technologies used in apparel and protective padding by providing adaptive, progressive response characteristics through a simple, self-contained design that requires no external power or control systems. The system's ability to dissipate energy through controlled fluid movement between chambers makes it valuable for numerous athletic, protective, and comfort applications where impact absorption, vibration damping, or adaptive cushioning enhances the wearer's experience. The passive nature of the damping mechanism ensures reliable operation without the complexity, weight, or potential failure points associated with electronically controlled systems, while providing superior performance compared to conventional fixed-response damping materials commonly used in protective apparel. The progressive damping effect that varies with the rate of compression applied to the first fluid chamber enables the system to automatically adapt to different impact conditions without manual adjustment or external control.

While specific embodiments of the fluid-filled damper system have been described, various modifications, alterations, and adaptations may be made by those skilled in the art without departing from the spirit and scope of the present disclosure. The specific shapes of the chambers, the configuration of the flow restrictor, and the materials used may be modified to suit particular apparel or protective padding applications or manufacturing constraints while still embodying the core principles of the invention.

Additional disclosure of features and alternate/additional uses for the fluid-filled damper are described in U.S. patent application Ser. No. 19/219,653, filed 27 May 2025, entitled Motorized Ambulatory Assist Device, the entire disclosure of which is incorporated by reference in its entirety and for everything that it discloses.

1. A fluid-filled damper system for an article of apparel or protective padding, the system comprising:
a flexible bladder defining a first fluid chamber and a second fluid chamber;
a flow restrictor providing fluidic communication between the first fluid chamber and the second fluid chamber, the flow restrictor configured to limit a rate of fluid transfer between the first fluid chamber and the second fluid chamber; and
a fluid contained within the first fluid chamber and the second fluid chamber;
wherein compression of the first fluid chamber causes a portion of the fluid to flow through the flow restrictor into the second fluid chamber at a rate regulated by the flow restrictor, creating a progressive damping effect that varies with a rate of compression applied to the first fluid chamber, whereby the fluid-filled damper system provides impact protection by dissipating force through controlled fluid movement between the first fluid chamber and the second fluid chamber during physical activity of a wearer.

2. The fluid-filled damper system of claim 1, wherein the flow restrictor comprises a necked transition zone extending between the first fluid chamber and the second fluid chamber, the necked transition zone having a cross-sectional area smaller than cross-sectional areas of both the first fluid chamber and the second fluid chamber.

3. The fluid-filled damper system of claim 2, wherein the necked transition zone has a cross-sectional area that is approximately 2% to 50% of the cross-sectional areas of the first fluid chamber and the second fluid chamber.

4. The fluid-filled damper system of claim 1, wherein the flexible bladder is constructed from a flexible, resilient material selected from the group consisting of thermoplastic polyurethane (TPU), polyvinyl chloride (PVC), and elastomeric polymers.

5. The fluid-filled damper system of claim 1, wherein the flexible bladder comprises at least one impermeable barrier layer integrated into walls of the flexible bladder, the at least one impermeable barrier layer configured to restrict diffusion of the fluid through the walls of the flexible bladder.

6. The fluid-filled damper system of claim 1, wherein the fluid comprises a gaseous medium selected from the group consisting of air, nitrogen, helium, and combinations thereof.

7. The fluid-filled damper system of claim 1, wherein the fluid comprises an incompressible or partially compressible liquid.

8. The fluid-filled damper system of claim 1, wherein the flow restrictor is configured to provide directionally-dependent flow resistance such that a rate of fluid transfer from the first fluid chamber to the second fluid chamber differs from a rate of fluid transfer from the second fluid chamber to the first fluid chamber under equivalent pressure differentials.

9. The fluid-filled damper system of claim 1, wherein the first fluid chamber and the second fluid chamber have different internal volumes, creating a progressive damping response during compression and recovery cycles.

10. The fluid-filled damper system of claim 9, wherein the first fluid chamber has an internal volume that is 1.0 to 3 times larger than the second fluid chamber.

11. The fluid-filled damper system of claim 1, further comprising a plurality of flow restrictors providing multiple fluid pathways between the first fluid chamber and the second fluid chamber, wherein individual flow restrictors of the plurality of flow restrictors have different flow resistance characteristics relative to each other.

12. An article of apparel comprising:
a garment structure configured to be worn on a portion of a human body and comprising athletic apparel selected from the group consisting of protective sportswear, compression wear, and technical performance clothing; and
a fluid-filled damper system integrated into the garment structure, the fluid-filled damper system comprising:
a flexible bladder defining a first fluid chamber and a second fluid chamber;
a flow restrictor providing fluidic communication between the first fluid chamber and the second fluid chamber, the flow restrictor configured to limit a rate of fluid transfer between the first fluid chamber and the second fluid chamber; and
a fluid contained within the first fluid chamber and the second fluid chamber;
wherein compression of the first fluid chamber causes a portion of the fluid to flow through the flow restrictor into the second fluid chamber at a rate regulated by the flow restrictor, creating a progressive damping effect that provides impact protection during physical activity of a wearer.

13. The article of apparel of claim 12, wherein the fluid-filled damper system is positioned within a protective region of the garment structure selected from the group consisting of an impact zone, a pressure point region, and a joint protection area.

14. The article of apparel of claim 12, wherein the flexible bladder is configured to conform to a contour of the portion of the human body when the garment structure is worn.

15. The article of apparel of claim 12, wherein the flow restrictor is configured to provide progressive resistance that increases proportional to increasing rate of impact forces applied to the fluid-filled damper system, thereby providing greater damping during high-velocity impacts than during low-velocity impacts.

16. The article of apparel of claim 12, further comprising a plurality of fluid-filled damper systems integrated into different regions of the garment structure, wherein individual fluid-filled damper systems are configured with different damping characteristics appropriate for protection requirements of their respective regions.

17. A protective pad for athletic equipment comprising:
a protective outer shell configured to receive an impact force during athletic activity;
a comfort layer configured to contact a wearer's body; and
a fluid-filled damper system positioned between the protective outer shell and the comfort layer, the fluid-filled damper system comprising:
a flexible bladder defining a first fluid chamber positioned adjacent to the protective outer shell and a second fluid chamber positioned adjacent to the comfort layer;
a flow restrictor providing fluidic communication between the first fluid chamber and the second fluid chamber, the flow restrictor configured to limit a rate of fluid transfer between the first fluid chamber and the second fluid chamber; and
a fluid contained within the first fluid chamber and the second fluid chamber; wherein compression of the first fluid chamber by the impact force causes a portion of the fluid to flow through the flow restrictor into the second fluid chamber, creating a resistance force that increases with increasing rate of the impact force.

18. The protective pad of claim 17, wherein the protective pad is configured to protect a body region selected from the group consisting of a shoulder, an elbow, a hip, a knee, a shin, and a thigh during athletic activity.

19. The protective pad of claim 17, wherein the protective outer shell comprises a semi-rigid material configured to distribute impact forces across a surface area of the first fluid chamber.

20. The protective pad of claim 17, wherein the flow restrictor is configured such that rapid compression of the first fluid chamber creates greater resistance to fluid transfer than gradual compression of the first fluid chamber, providing enhanced protection during sudden impacts compared to sustained pressure.

21. The protective pad of claim 17, wherein the flow restrictor comprises an elongated channel passage having a cross-sectional area smaller than cross-sectional areas of both the first fluid chamber and the second fluid chamber, the elongated channel passage configured to create controlled energy dissipation during fluid transfer between the first fluid chamber and the second fluid chamber.
